(19) United States
(12) Patent Application Publication
(10) Pub. No.: US 2020/0265119 A1
(43) Pub. Date: Aug. 20, 2020

(54) SITE-SPECIFIC ANOMALY DETECTION

(71) Applicant: Accenture Global Solutions Limited, Dublin (IE)

(72) Inventors: Vijay DESAI, San Diego, CA (US); Revathi SUBRAMANIAN, San Diego, CA (US); Kun QIU, San Diego, CA (US)

(21) Appl. No.: 16/276,198

(22) Filed: Feb. 14, 2019

(51) Int. Cl. G06F 17/50; G06Q 50/06; G06F 17/16; G06N 7/00

(52) U.S. Cl. CPC G06F 17/50; G06N 7/005; G06F 17/16; G06Q 50/06

(57) ABSTRACT

A device may receive utility usage data for multiple buildings across multiple locations. The device may process the utility usage data using a first set of models associated with performing at least one of: an intra-building anomaly detection for the utility usage data, a first grouping of the utility usage data based on characteristics of the utility usage data, or a second grouping of the utility usage data based on the multiple locations. The device may process first output from the first set of models using a second set of models associated with pre-processing the first output in association with identifying anomalies in the first grouping or in the second grouping. The device may process the first output and second output from the second set of models using a super model associated with identifying the anomalies. The device may perform, based on the score, one or more actions.

### BACKGROUND

Anomaly detection is the identification of rare items, events, or observations which differ significantly from data being analyzed. Anomaly detection is used for intrusion detection, fault detection, system health monitoring, event detection, and/or the like.

### SUMMARY

According to some implementations, a method may comprise receiving, by a device, utility usage data for multiple buildings across multiple locations, wherein the utility usage data identifies utility usage of one or more utilities by each of the multiple buildings; processing, by the device, the utility usage data using a first set of models after receiving the utility usage data, wherein the first set of models includes at least one of: a model related to performing an intra-building anomaly detection for the utility usage data, a model related to determining a data-based grouping of the utility usage data, or a model related to determining a location-based grouping of the utility usage data; processing, by the device and using a second set of models, first output from the first set of models after processing the utility usage data, to obtain second output from the second set of models; processing, by the device and using a super model, the first output from the first set of models and the second output from the second set of models, wherein the super model is associated with identifying anomalies related to the utility usage of one or more of the multiple buildings; and performing, by the device, one or more actions after processing the first output and the second output using the super model.

According to some implementations, a device may comprise one or more memories; and one or more processors, communicatively coupled to the one or more memories, to: receive utility usage data for multiple buildings across multiple locations, wherein the utility usage data identifies a utility usage of one or more utilities by each of the multiple buildings, wherein the utility usage data is received from respective sets of utility meters associated with the multiple buildings; process the utility usage data using a first set of models after receiving the utility usage data, wherein the first set of models includes at least two of: a model related to performing an intra-building anomaly detection for the utility usage data, a model related to determining a data-based grouping of the utility usage data, or a model related to determining a location-based grouping of the utility usage data; process, using a second set of models, first output from the first set of models after processing the utility usage data using the first set of models, wherein the second set of models is associated with processing the utility usage data for various groupings of the utility usage data identified from the first set of models; process, using a super model, the first output and second output from the second set of models to identify a possible anomaly in the utility usage data; perform, after processing the first output and the second output, a decomposition of the utility usage data to identify a utility element, of the one or more utilities, that caused the possible anomaly; and perform one or more actions after performing the decomposition of the utility usage data.

According to some implementations, a non-transitory computer-readable medium storing instructions, the instructions comprising: one or more instructions that, when executed by one or more processors, cause the one or more processors to: receive utility usage data for multiple buildings across multiple locations, wherein the utility usage data identifies a utility usage of one or more utilities by each of the multiple buildings; process the utility usage data using a first set of models after receiving the utility usage data, wherein the first set of models is associated with performing at least one of: an intra-building anomaly detection for the utility usage data, a first grouping of the utility usage data based on characteristics of the utility usage data, or a second grouping of the utility usage data based on the multiple locations; process first output from the first set of models using a second set of models after processing the utility usage data using the first set of models, wherein the second set of models is associated with pre-processing the first output in association with identifying anomalies in the first grouping or in the second grouping; process the first output and second output from the second set of models using a super model after processing the first output using the second set of models, wherein the super model is associated with identifying the anomalies in a context of the first output and the second output, wherein third output from the super model includes a score that identifies a presence of one or more of the anomalies in the utility usage data; and perform, based on the score, one or more actions after processing the first output and the second output using the super model.

### BRIEF DESCRIPTION OF THE DRAWINGS

FIGS. 1A-3D are diagrams of example implementations described herein.

FIG. 4 is a diagram of an example environment in which systems and/or methods described herein may be implemented.

FIG. 5 is a diagram of example components of one or more devices of FIG. 2.

FIGS. 6-8 are flow charts of example processes for site-specific anomaly detection.

### DETAILED DESCRIPTION

The following detailed description of example implementations refers to the accompanying drawings. The same reference numbers in different drawings may identify the same or similar elements.

Different buildings (or sites) across different locations may use one or more utilities in different manners. For example, the different buildings may use different combinations of utilities (e.g., electricity, gas, water, telecommunications services, and/or the like), may use different amounts of the same utility (e.g., due to being in different locations, having different sizes, being associated with different uses, and/or the like), and/or the like. As a result, respective sets of utility meters for the different buildings may gather unique patterns of utility usage data related to the utility usages of the different buildings. Processing this utility usage data for anomaly detection using conventional techniques and/or computing resources may be difficult, if not impossible, due to the large quantity of data elements included in the utility usage data (e.g., each utility meter may gather thousands, millions, or more data elements related to utility usage), the unique patterns of utility usage data for different buildings (e.g., each building may use a unique mix and/or amount of one or more utilities), and/or the like. For example, the large quantity of data elements may overload conventional computing resources and/or may require a significant amount of time to be processed, thereby causing the conventional computing resources to crash and/or freeze during processing of the data elements. Additionally, or alternatively, the conventional computing resources may not be capable of identifying and/or processing the unique patterns of utility usage data accurately.

Some implementations described herein provide an anomaly detection platform that is capable of receiving utility usage data from respective sets of utility meters for multiple buildings across multiple locations and processing the utility usage data using various models to detect an anomaly with respect to the utility usage data in a context of respective historical utility usages of the multiple buildings, of buildings in a same location, of buildings associated with a similar use, and/or the like. In this way, the anomaly detection platform provides a tool that can accurately determine respective unique signatures of utility usage data for the multiple buildings, and can identify the presence of possible anomalies in the utility usage data. Using the anomaly detection platform to process utility usage data in this manner reduces an amount of time needed to process the utility usage data relative to using conventional computing resources to process the utility usage data. In addition, using the anomaly detection platform to process the utility usage data in this manner provides accurate identification of possible anomalies in the utility usage data. Further, using the anomaly detection platform in this manner conserves computing resources that would otherwise be wasted using conventional computing resources (e.g., that would be wasted as a result of crashes, freezes, and/or the like of the conventional computing resources). Further, by providing a tool that can be used to process utility usage data in a new and efficient manner, the anomaly detection platform provides a new tool for anomaly detection.

Further, in this way, the anomaly detection platform removes human subjectivity and waste from anomaly detection, and may improve speed and efficiency of the process for anomaly detection and conserve computing resources (e.g., processor resources, memory resources, and/or the like). Furthermore, implementations described herein use a rigorous, computerized process to perform tasks or roles that were not previously performed, thereby providing a new tool for analysis of utility usage data. Further, a process for detecting an anomaly in utility usage data conserves computing resources (e.g., processor resources, memory resources, and/or the like) of a device that would otherwise be wasted in attempting to use another technique to process utility usage data to detect an anomaly in the utility usage data.

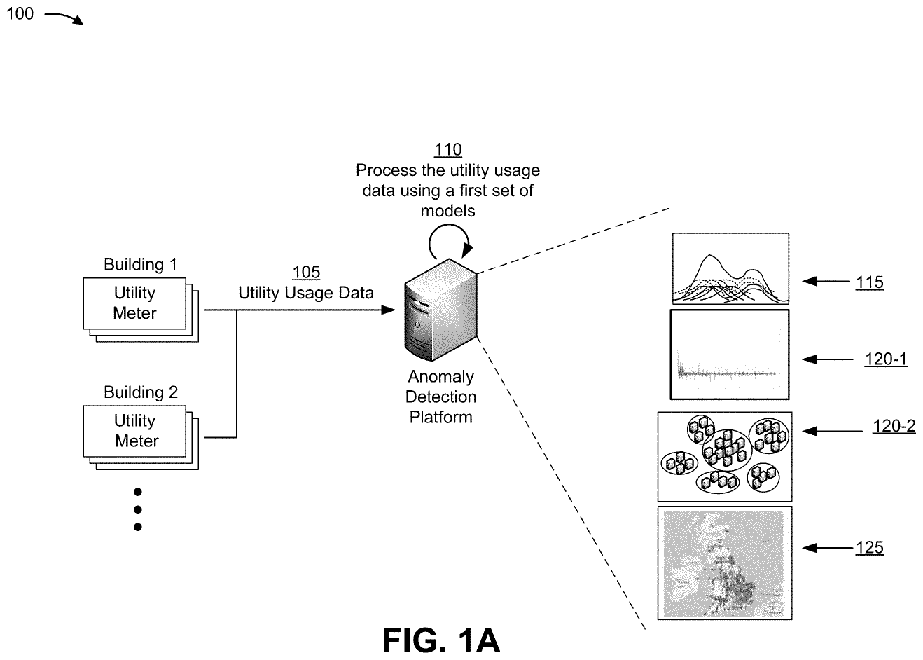

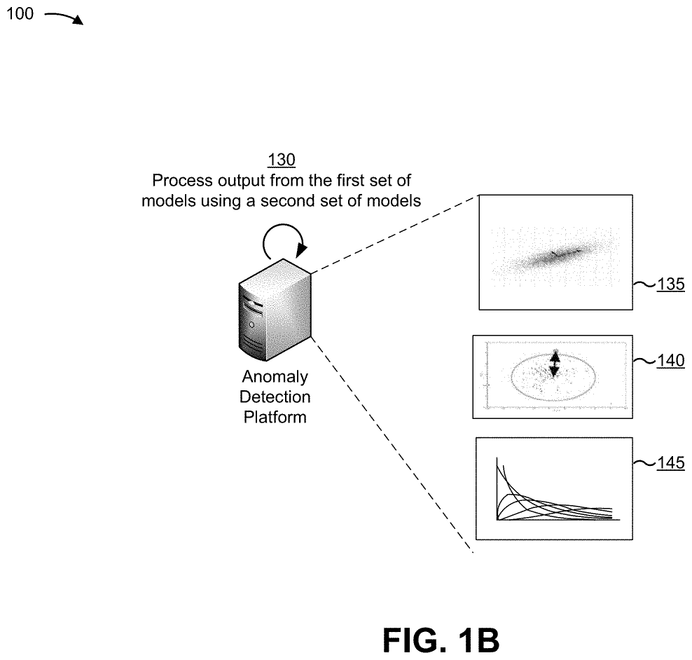

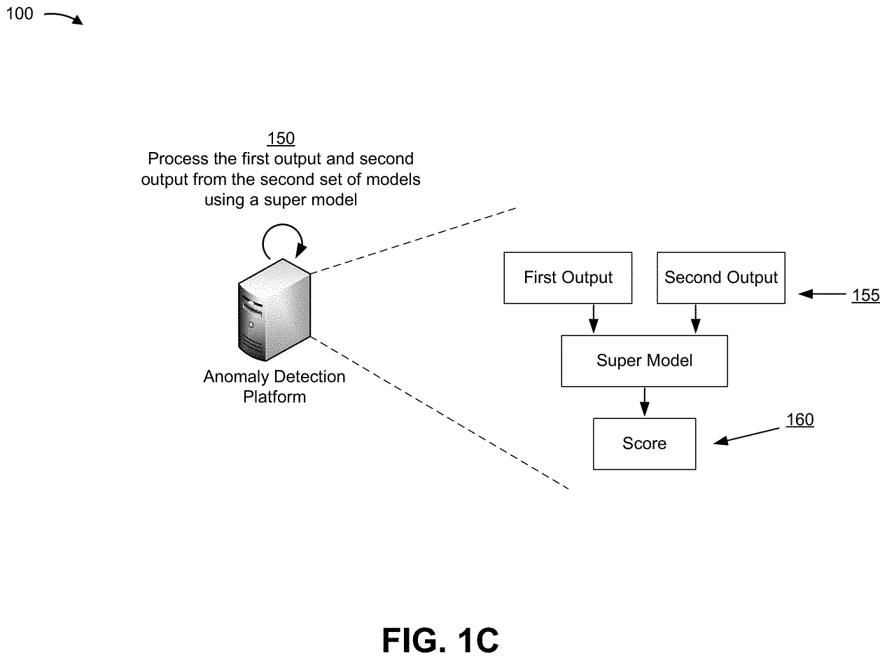

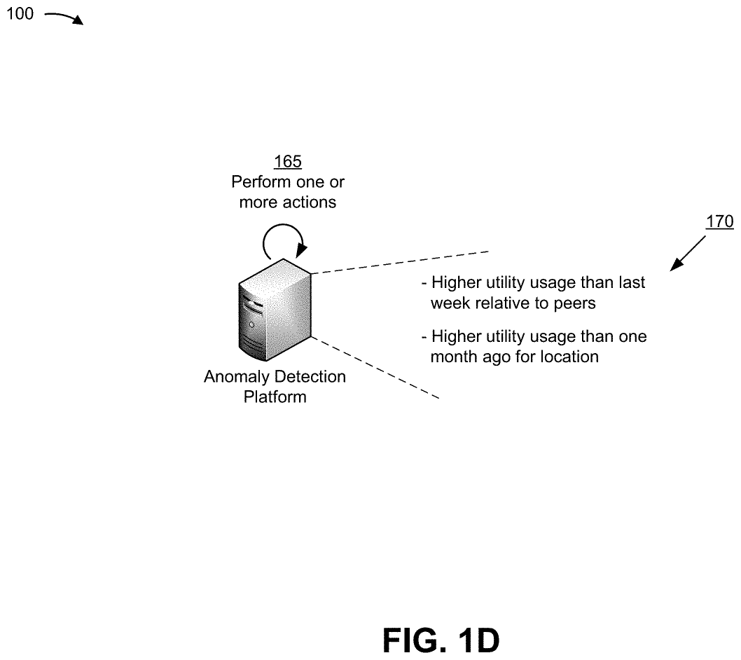

FIGS. 1A-1D are diagrams of one or more example implementations 100 described herein. As shown, example implementation(s) 100 include respective sets of utility meters for multiple buildings and an anomaly detection platform.

As shown by reference number 105, a set of utility meters associated with a building may send, to the anomaly detection platform, utility usage data. For example, the set of utility meters may send the utility usage data periodically, according to a schedule, based on receiving a request for the utility usage data from the anomaly detection platform, in real-time or near real-time (e.g., as the utility usage data is gathered), and/or the like. In some implementations, the anomaly detection platform may receive the utility usage data directly from the set of utility meters. Alternatively, the anomaly detection platform may receive the utility usage data from a server device, or another device, that monitors, aggregates, stores, and/or the like utility usage data from the set of utility meters. In some implementations, a utility meter may include an electricity meter, a gas meter, a water meter, a sewage meter, a telecommunications meter (e.g., for telecommunications services, such as a telephone service, an Internet service, a mobile data service, and/or the like), and/or the like. In some implementations, a utility meter may monitor usage of a utility (e.g., a utility may include electricity, gas, water, mobile data, and/or the like that is being metered and consumed by the building). In some implementations, a utility meter may include one or more components, such as a processor, a communication interface, an antenna, and/or the like that the utility meter can use to transmit the utility usage data to the anomaly detection platform (e.g., via a wired or wireless network).

In some implementations, the anomaly detection platform may receive the utility usage data in various forms. For example, the anomaly detection platform may receive the utility usage data in the form of a stream of data from the respective sets of utility meters, an image (e.g., an image of a utility bill, and/or the like from a client device, a server device, and/or the like), as text (e.g., as text of a utility bill from a billing system, and/or the like), as application data from an application hosted, executed, and/or the like, on a server device and/or a client device, as input to the anomaly detection platform (e.g., via a user interface associated with the anomaly detection platform), as tabular data (e.g., in the form of a spread sheet file, a comma-separated values (CSV) file, and/or the like), and/or the like.

In some implementations, the utility usage data may include millions, billions, or more data elements. In this way, the utility usage data includes a set of data that may overload conventional computing resources. In some implementations, the utility usage data may be time series data that shows utility usage over an amount of time. In some implementations, the utility usage data may identify a utility associated with the utility usage data, an amount of the utility consumed during a time period (or a cumulative amount of the utility consumed since a starting time), a building with which the utility usage data is associated, a type of use of the building (e.g., retail, residential, manufacturing, office space, and/or the like), respective locations of the multiple buildings and/or utility meters of the respective sets of utility meters, and/or the like. In some implementations, the anomaly detection platform may receive historical utility usage data that shows a historical utility usage. For example, the anomaly detection platform may use the historical utility usage data to train one or more models described elsewhere herein.

In some implementations, the utility usage data may include various subsets of utility usage data. For example, a subset of utility usage data may be related to a particular building, a particular floor of the building, a particular utility, and/or the like. In some implementations, and as described elsewhere herein, the anomaly detection platform may decompose utility usage data into the various subsets of data to accurately and precisely identify a source of an anomaly in the utility usage data, such as a particular building, a particular utility, and/or the like that is a source of the anomaly.

In some implementations, the anomaly detection platform may organize the utility usage data after receiving the utility usage data based on unique identifiers included in the utility usage data (e.g., unique identifiers that uniquely identify a building associated with the utility usage data, a location associated with the utility usage data, a utility associated with the utility usage data, and/or the like). In some implementations, the unique identifiers may be included in the utility usage data as attributes of the data (e.g., as a field with a unique value, such as a name, an identification number, and/or the like), and the anomaly detection platform may organize the utility usage data based on the unique identifiers included as the attributes in the utility usage data.

Additionally, or alternatively, the anomaly detection platform may process the utility usage data to identify the unique identifiers. For example, the anomaly detection platform may process images using an image processing technique, such as a computer vision technique, a feature detection technique, an optical character recognition (OCR) technique, and/or the like to identify an alphanumeric string, a symbol, a code (e.g., a barcode, a matrix barcode, and/or the like) in the image (e.g., that identify the presence of a unique identifier, that are a unique identifier, and/or the like). Continuing with the previous example, the anomaly detection platform may compare the alphanumeric string, the symbol, the code, and/or the like to information stored in a data structure and/or in memory resources of the anomaly detection platform to determine which unique identifiers are included in the image.

Additionally, or alternatively, and as another example, the anomaly detection platform may process the utility usage data using a text processing technique, such as a natural language processing technique, a text analysis technique, and/or the like (e.g., when the anomaly detection platform receives utility usage data from a device other than a utility meter). Continuing with the previous example, the anomaly detection platform may process the text to identify an alphanumeric string, a symbol, a code, and/or the like included in the utility usage data (e.g., that indicate a presence of a unique identifier, that are a unique identifier, and/or the like), and may identify the unique identifiers included in the text in a manner similar to that described above.

Additionally, or alternatively, and as another example, the anomaly detection platform may process the utility usage data using a model (e.g., a machine learning model, an artificial intelligence model, and/or the like) to identify a unique identifier included in the utility usage data. For example, the anomaly detection platform may use the model to process an image and/or text to identify an alphanumeric string, a symbol, a code, and/or the like included in the utility usage data, to identify an area of the utility usage data (e.g., an area of an image and/or text) that likely includes a unique identifier, and/or the like (e.g., based on having been trained to identify unique identifiers in the utility usage data, a likely area in the utility usage data that may include a unique identifier, and/or the like). In some implementations, the model and/or training of the model may be similar to that described elsewhere herein.

As shown by reference number 110, the anomaly detection platform may process the utility usage data using a first set of models. For example, the anomaly detection platform may process the utility usage data using the first set of models after receiving the utility usage data, based on receiving input from a user of the anomaly detection platform to process the utility usage data using the first set of models, at a scheduled time, and/or the like. In some implementations, the anomaly detection platform may process data extracted from a utility bill using a text processing technique, an image processing technique, and/or the like similar to that described elsewhere herein.

In some implementations, the first set of models may include one or more models related to performing an intra-building anomaly detection for the utility usage data, related to determining a data-based grouping of the utility usage data, related to determining a location-based grouping of the utility usage data, based on a building type (e.g., an office building, a refrigerated warehouse, a storage building, and/or the like), and/or the like, as described elsewhere herein. In some implementations, a model described herein may include a machine learning model, an artificial intelligence model, and/or the like, as described elsewhere herein. In some implementations, the anomaly detection platform may process the utility usage data using the first set of models by inputting the utility usage data into the first set of models.

In some implementations, prior to processing the utility usage data, the anomaly detection platform may prepare and/or pre-process the utility usage data. For example, the anomaly detection platform may identify keywords included in the utility usage data, such as unique identifiers that are common across the utility usage data related to particular buildings, particular locations, and/or the like. Additionally, or alternatively, the anomaly detection platform may remove leading and/or trailing spaces from text included in the utility usage data, may remove non-American Standard Code for Information Interchange (non-ASCII) characters from the utility usage data, and/or the like. This facilitates quick and/or easy processing of the utility usage data by making the utility usage data more uniform, thereby facilitating fast training of and/or processing by the first set of models.

In some implementations, the anomaly detection platform may generate the first set of models by training a set of machine learning models. For example, the anomaly detection platform may train the set of machine learning models to generate the first set of models from the utility usage data (e.g., historical utility usage data). In some implementations, the anomaly detection platform may train a machine learning model on a training set of data. For example, the training set of data may include historical utility usage data, information that identifies anomalies in the historical utility usage data, and/or the like. Additionally, or alternatively, when the anomaly detection platform inputs the utility usage data into the machine learning model, the anomaly detection platform may input a first portion of the utility usage data as a training set of data, a second portion of the utility usage data as a validation set of data, and third portion of the utility usage data as a test set of data (e.g., to be used to determine a model included in the first set of models). In some implementations, the anomaly detection platform may perform multiple iterations of training of the machine learning model, depending on an outcome of testing of the machine learning model (e.g., by submitting different portions of the utility usage data as the training set of data, the validation set of data, and the test set of data).

In some implementations, when training the machine learning model, the anomaly detection platform may utilize a random forest classifier technique to train the machine learning model. For example, the anomaly detection platform may utilize a random forest classifier technique to construct multiple decision trees during training and may output a classification of utility usage data. Additionally, or alternatively, when training the machine learning model, the anomaly detection platform may utilize a gradient boost tree classifier technique to generate the machine learning model. For example, the anomaly detection platform may utilize a gradient boost tree classifier technique to generate a prediction model from a set of weak prediction models (e.g., by generating the machine learning model in a stage-wise manner, by optimizing an arbitrary differentiable loss function, and/or the like).

In some implementations, when training the machine learning model, the anomaly detection platform may utilize logistic regression to train the machine learning model. For example, the anomaly detection platform may utilize a binary classification of the utility usage data (e.g., whether the utility usage data includes an anomaly) to train the machine learning model to determine a model included in the first set of models based on the classification of the utility usage data. Additionally, or alternatively, when training the machine learning model, the anomaly detection platform may utilize a naive Bayes classifier to train the machine learning model. For example, the anomaly detection platform may utilize binary recursive partitioning to divide the utility usage data into various binary categories (e.g., starting with anomalous or non-anomalous utility usage data binary categories). Based on using recursive partitioning, the anomaly detection platform may reduce utilization of computing resources relative to manual, linear sorting and analysis of data points, thereby enabling use of thousands, millions, or billions of data points to train a machine learning model, which may result in a more accurate machine learning model than using fewer data points.

Additionally, or alternatively, when training the machine learning model, the anomaly detection platform may utilize a support vector machine (SVM) classifier. For example, the anomaly detection platform may utilize a linear model to implement non-linear class boundaries, such as via a max margin hyperplane. Additionally, or alternatively, when utilizing the SVM classifier, the anomaly detection platform may utilize a binary classifier to perform a multi-class classification. Use of an SVM classifier may reduce or eliminate overfitting, may increase a robustness of the machine learning model to noise, and/or the like.

In some implementations, the anomaly detection platform may train the machine learning model using a supervised training procedure that includes receiving input to the machine learning model from a subject matter expert. In some implementations, the anomaly detection platform may use one or more other model training techniques, such as a neural network technique, a latent semantic indexing technique, and/or the like. For example, the anomaly detection platform may perform an artificial neural network processing technique (e.g., using a two-layer feedforward neural network architecture, a three-layer feedforward neural network architecture, and/or the like) to perform pattern recognition with regard to patterns of utility usage data, patterns of utility usage data that includes an anomaly, and/or the like. In this case, using the artificial neural network processing technique may improve an accuracy of a model generated by the anomaly detection platform by being more robust to noisy, imprecise, or incomplete data, and by enabling the anomaly detection platform to detect patterns and/or trends undetectable to human analysts or systems using less complex techniques.

As an example, the anomaly detection platform may use a supervised multi-label classification technique to train the machine learning model. For example, as a first step, the anomaly detection platform may map utility usage data to a set of previously generated models after labeling the utility usage data. In this case, the utility usage data may be characterized as having been accurately or inaccurately determined to include an anomaly (e.g., by a technician, thereby reducing processing relative to the anomaly detection platform being required to analyze utility usage data for each building, location, and/or the like). As a second step, the anomaly detection platform may determine classifier chains, whereby labels of target variables may be correlated. In this case, the anomaly detection platform may use an output of a first label as an input for a second label (as well as one or more input features, which may be other utility usage data), and may determine a likelihood that utility usage data includes an anomaly and/or is similar to other utility usage data. In this way, the anomaly detection platform transforms classification from a multilabel-classification problem to multiple single-classification problems, thereby reducing processing utilization. As a third step, the anomaly detection platform may determine a Hamming Loss Metric relating to an accuracy of a label in performing a classification by using the validation set of the data (e.g., an accuracy with which a weighting is applied to utility usage data and whether the utility usage data includes an anomaly, results in a correct prediction of including an anomaly, and/or the like, thereby accounting for variations among different buildings, locations, and/or the like). As a fourth step, the anomaly detection platform may finalize the machine learning model based on labels that satisfy a threshold accuracy associated with the Hamming Loss Metric, and may use the machine learning model for subsequent determination of machine learning models.

In some implementations, rather than training a machine learning model to generate a model included in the first set of models, the anomaly detection platform may receive a model included in the first set of models from another device. For example, the anomaly detection platform may receive the model included in the first set of models from a server device that previously trained a machine learning model in the manner described herein to generate the model included in the first set of models.

As shown by reference number 115, the first set of models may include a kernel density estimation (KDE) model. For example, the KDE model may use a kernel parameter and a kernel bandwidth parameter to process utility usage data to make a prediction related to whether the utility usage data includes an anomaly. In some implementations, the anomaly detection platform may use the KDE model to perform an intra-building anomaly detection for the utility usage data (e.g., by comparing utility usage data for a building from a time period to historical utility usage data for the building). In some implementations, the KDE model may output an estimation of a probability density function of the utility usage data.

As shown by reference numbers 120-1 and 120-2, the first set of models may include a set of models related to determining a data-based grouping of the utility usage data. For example, and as shown by reference number 120-1, the first set of models may include a discrete cosine transform (DCT) model. Continuing with the previous example, the anomaly detection platform may use the DCT model to process the utility usage data in terms of a sum of cosine functions oscillating at different frequencies. In some implementations, the first set of models may include a discrete Fourier transform (DFT) model rather than a DCT model; however, using a DCT model may provide improved compression of the utility usage data in a frequency domain relative to the DFT model.

Additionally, or alternatively, and as shown by reference number 120-2, the first set of models may include a k-means clustering model. Continuing with the previous example, the anomaly detection platform may use a k-means clustering model where utility usage data is partitioned into clusters with a nearest mean. In some implementations, the k-means clustering model may output information that identifies groupings of the utility usage data (e.g., by values of the utility usage data, by patterns in values of the utility usage data, and/or the like).

In some implementations, the anomaly detection platform may process the utility usage data using a combination of the DCT model and the k-means clustering model. In some implementations, and in a first step, the anomaly detection platform may process utility usage data using the DCT model to generate a spectrum of the utility usage data. In some implementations, and in a second step, the anomaly detection platform may perform a compression of the spectrum generated from the DCT model. For example, the anomaly detection platform may compress the spectrum by retaining a top threshold percentage (e.g., five percent, 15 percent, 30 percent, etc.) of the largest frequency aspects of the spectrum and may remove the remaining frequency aspects. This removes noise and/or minor frequency fluctuations from the spectrum. In some implementations, and in a third step, the anomaly detection platform may process the compressed spectrum using the k-means clustering model. For example, the anomaly detection platform may use compressed DCT coefficients associated with the compressed spectrum as features for a particular building, location, utility, and/or the like. Continuing with the previous example, the anomaly detection platform may group buildings using the k-means clustering model based on the compressed DCT coefficients.

In this way, utility usage data is grouped by patterns in the utility usage data, such as by day, week, month, and/or the like. In addition, using a combination of the DCT model and the k-means clustering model facilitates calculation of a score that indicates a likelihood of an anomaly being present in the utility usage data by comparing recent patterns of utility usage within each grouping of utility usage data (e.g., deviating patterns within a group may be identified as anomalous). Further, the anomaly detection platform may use these techniques to quickly and efficiently group new buildings with existing groups of buildings, which can reduce an amount of time needed to detect anomalies in utility usage of the new buildings. Further, this technique provides improved accuracy with increased quantities of buildings, thereby facilitating scaling of the technique to hundreds, thousands, or more buildings.

As shown by reference number 125, the first set of models may include another k-means clustering model. For example, the anomaly detection platform may use the other k-means clustering model to determine a location-based grouping of the utility usage data. Continuing with the previous example, the anomaly detection platform may determine groupings of the utility usage data based on respective locations (e.g., street locations, cities, countries, and/or the like) of the multiple buildings associated with the utility usage data. In some implementations, the k-means clustering model may output information that identifies groupings of the utility usage data by locations of buildings associated with the utility usage data.

Turning to FIG. 1B, and as shown by reference number 130, the anomaly detection platform may process output from the first set of models using a second set of models. For example, the anomaly detection platform may process output from the first set of models using the second set of models after using the first set of models to process the utility usage data, for example at a scheduled time, based on receiving input from a user of the anomaly detection platform to process the output from the first set of models, and/or the like. In some implementations, the second set of models may include a machine learning model, an artificial intelligence model, and/or the like, similar to that described elsewhere herein. In some implementations, the second set of models is related to performing an inter-building anomaly detection and identifying the most anomalous buildings among peers in a group determined from a data-based grouping or a location-based grouping described herein.

As shown by reference number 135, the second set of models may include a principal component analysis (PCA) feature reduction model. For example, the anomaly detection platform may use the PCA feature reduction model to perform a linear mapping of the utility usage data to a lower-dimensional space such that a variance of the utility usage data in a low-dimensional representation is maximized. In some implementations, the PCA feature reduction model may output information that identifies a linear mapping of the utility usage data.

As shown by reference number 140, the second set of models may include a Mahalanobis distance model. For example, the anomaly detection platform may use the Mahalanobis distance model to measure a distance between a particular data point in the utility usage data and a distribution of the utility usage data (e.g., to generalize measurement of a quantity of standard deviations that a particular data point is from a mean of the distribution). In some implementations, the Mahalanobis distance model may output information that identifies a measurement of the distance between the particular data point in the utility usage data and the distribution of the utility usage data.

As shown by reference number 145, the second set of models may include a chi-square probability model. For example, the anomaly detection platform may use the chi-square probability model to determine chi-square probability scores for the utility usage data. In some implementations, the chi-square probability model may output chi-square probability scores for various buildings, for various locations, for various utilities, and/or the like associated with the utility usage data.

Turning to FIG. 1C, and as shown by reference number 150, the anomaly detection platform may process the first output and second output from the second set of models using a super model. For example, the anomaly detection platform may process the first output and the second output after processing the first output using the second set of models, based on receiving input from a user of the anomaly detection platform to process the first output and the second output using the super model, at a scheduled time, and/or the like.

In some implementations, the super model may include a machine learning model, an artificial intelligence model, and/or the like, similar to that described elsewhere herein. For example, the super model may include an isolation forest model. Continuing with the previous example, the anomaly detection platform may construct multiple decision trees for the isolation forest model during training of the super model, and the isolation forest model may output a classification of the utility usage data (e.g., a classification of whether the utility usage data includes an anomaly, a classification of a type of anomaly included in the utility usage data, and/or the like).

As shown by reference number 155, the anomaly detection platform may process the first output and the second output using the super model. For example, the anomaly detection platform may process first output from the KDE model, second output from the second set of models, and/or the like using the super model. Continuing with the previous example, the anomaly detection platform may process first output from the KDE model, second output from the second set of models, and/or the like, using decision trees of an isolation forest to determine a likelihood that the utility usage data includes an anomaly. Continuing still with the previous example, the isolation forest may process the first output to determine whether utility usage data for a particular building includes an anomaly based on other utility usage data for other buildings in a same location as the particular building, for other buildings that are used in a similar way (e.g., other office buildings when the particular building is an office building, other factories when the particular building is a factory, and/or the like), and/or the like.

In some implementations, the anomaly detection platform may process the first output and the second output using the super model by inputting the first output and the second output into the super model. For example, the anomaly detection platform may input the first output into the super model (and may process the first output) prior to inputting (and processing) the second output, may input the second output (and may process the second output) prior to inputting (and processing) the first output, may input the first output and the second output at a same time (and may process the first output and the second output at a same time), and/or the like.

As shown by reference number 160, the super model may output a score. For example, the super model may output a score based on processing the first output and the second output. In some implementations, the score may identify a likelihood that the utility usage data (e.g., for a particular building) includes an anomaly, includes a particular type of anomaly, and/or the like. In some implementations, the super model may output different scores for different buildings, for different locations, for different groupings of buildings identified in the first output and/or the second output, and/or the like. Additionally, or alternatively, the super model may output scores for different subsets of utility usage data (e.g., different utilities associated with the utility usage data) for different buildings, groupings, locations, and/or the like.

In some implementations, the anomaly detection platform may determine that a possible anomaly is present in the utility usage data when a score satisfies a threshold. For example, the anomaly detection platform may determine that the score satisfies a threshold, and may determine that a possible anomaly is present in the utility usage data based on the score satisfying the threshold. In some implementations, the anomaly detection platform may determine a severity of the possible anomaly based on a degree to which the score satisfies the threshold, based on which threshold, of multiple thresholds, the score satisfies, and/or the like. In some implementations, the anomaly detection platform may determine a priority of possible anomalies relative to each other based on relative values of the scores.

In some implementations, the anomaly detection platform may perform a decomposition of the utility usage data. For example, the anomaly detection platform may perform a decomposition of the utility usage data into various subsets of the utility usage data after processing the first output and the second output using the super model, based on detecting a possible anomaly in the utility usage data, based on receiving input from a user of the anomaly detection platform to perform the decomposition of the utility usage data, and/or the like. Although the anomaly detection platform is described as performing a decomposition after the super model outputs a score for the utility usage data, the anomaly detection platform may perform the decomposition at a different time. For example, the anomaly detection platform may perform the decomposition prior to processing the utility usage data using the first set of models, and may use the first set of models to process decomposed utility usage data.

In some implementations, when performing the decomposition, the anomaly detection platform may process the utility usage data using a short-time Fourier transform technique. For example, the anomaly detection platform may process the utility usage data using the short-time Fourier transform technique to form a spectrogram of the utility usage data in a frequency domain. In some implementations, when performing the decomposition, the anomaly detection platform may process the spectrogram of the utility usage data using a non-negative matrix factorization (NMF) algorithm. For example, the anomaly detection platform may process the utility usage data using the NMF algorithm to decompose the spectrogram into distinct subsets of data (e.g., where different subsets are associated with different utilities for different buildings, locations, groupings of buildings, and/or the like). In some implementations, the anomaly detection platform may use the NMF algorithm after processing the utility usage data using the short-time Fourier transform technique. In some implementations, the anomaly detection platform may process the distinct subsets of data using an inverse short-time Fourier transform technique. For example, the anomaly detection platform may process the distinct subsets using the inverse short-time Fourier transform technique to reconstruct the distinct subsets of data in a time domain. In some implementations, the anomaly detection platform may use the inverse short-time Fourier transform technique after processing the spectrogram using the NMF algorithm.

In some implementations, the anomaly detection platform may process the subsets of data using the first set of models, the second set of models, and/or the like, in a manner similar to that described elsewhere herein. In this way, by decomposing the utility usage data into subsets of data and processing the subsets of data, the anomaly detection platform may identify a possible source of a possible anomaly, such as a particular utility usage (e.g., utility element) for a building as a source of the possible anomaly, may confirm a presence of a possible anomaly, and/or the like. This improves an accuracy of the anomaly detection platform with regard to identifying possible anomalies in utility usage data and/or possible sources of the possible anomalies, which conserves processing resources that would otherwise be wasted via a less accurate identification, via inaccurately addressing a source of a possible anomaly, and/or the like.

Turning to FIG. 1D, and as shown by reference number 165, the anomaly detection platform may perform one or more actions. For example, the anomaly detection platform may perform one or more actions based on identifying a possible anomaly in the utility usage data, based on identifying a source of the possible anomaly, after processing the utility usage data using the super model, after performing the decomposition, based on receiving input from a user of the anomaly detection platform to perform the one or more actions, and/or the like.

In some implementations, when performing the one or more actions, the anomaly detection platform may send, to another device, a message that includes information that identifies the utility element associated with the possible anomaly (e.g., the utility for which a corresponding subset of data includes the possible anomaly). For example, the anomaly detection platform may send the message to a client device for display via a display associated with the client device. Additionally, or alternatively, when performing the one or more actions, the anomaly detection platform may send, to another device that utilizes the utility, a set of instructions related to modifying operations of the other device based on the possible anomaly. For example, the anomaly detection platform may send a set of instructions to a client device, to a server device, to an appliance (e.g., a washer, a dryer, a refrigerator, and/or the like), to a heating, ventilation, and air conditioning (HVAC) system, and/or the like.

Additionally, or alternatively, when performing the one or more actions, the anomaly detection platform may identify the utility associated with the possible anomaly (e.g., after performing the decomposition of the utility usage data and processing subsets of data output by the decomposition). Additionally, or alternatively, the anomaly detection platform may generate a recommendation related to addressing the possible anomaly after identifying the utility associated with the possible anomaly. For example, the anomaly detection platform may have been trained to generate a recommendation based on a training set of data that includes various historical anomalies and corresponding actions performed to address the historical anomalies. Continuing with the previous example, the anomaly detection platform may output the recommendation for display after generating the recommendation.

Additionally, or alternatively, when performing the one or more actions, the anomaly detection platform may generate a report that identifies a source of an anomaly. For example, the report may identify a building, a location, a utility, a group of buildings, a particular device, and/or the like associated with an anomaly. Additionally, or alternatively, when performing the action, the anomaly detection platform may output the report for display after generating the report. Additionally, or alternatively, the anomaly detection platform may perform the one or more actions based on the source of the anomaly identified in the report. For example, the anomaly detection platform may generate a recommendation that is specific to the source of the anomaly. Reference number 170 shows example output from the anomaly detection platform. For example, the output from the anomaly detection platform may identify an anomaly, a time period for the anomaly, and/or the like.

In this way, the anomaly detection platform provides a tool that can process a complex set of utility usage data from multiple buildings to identify an anomaly associated with the utility usage data and/or to perform an action related to addressing the anomaly. This conserves processing resources that would otherwise be wasted using conventional computing resources to process the utility usage data. In addition, using the anomaly detection platform to process utility usage data in this manner reduces or eliminates wasted use of utilities via quick and efficient identification of anomalies in utility usage data, and via performance of one or more actions related to addressing the anomalies. Further, using the anomaly detection platform to process utility usage data in this manner provides a more accurate and/or more thorough analysis of utility usage data relative to using conventional computing resources.

As indicated above, FIGS. 1A-1D are provided merely as one or more examples. Other examples may differ from what is described with regard to FIGS. 1A-1D. Although FIGS. 1A-1D are described in the context of processing utility usage data from a various utility meters, the implementations apply equally to processing other data from other types of devices and/or sensors in other contexts, such as vibration data from vibration sensors, temperature data from temperature sensors, vehicle operation data from on-board diagnostic systems, and/or the like.

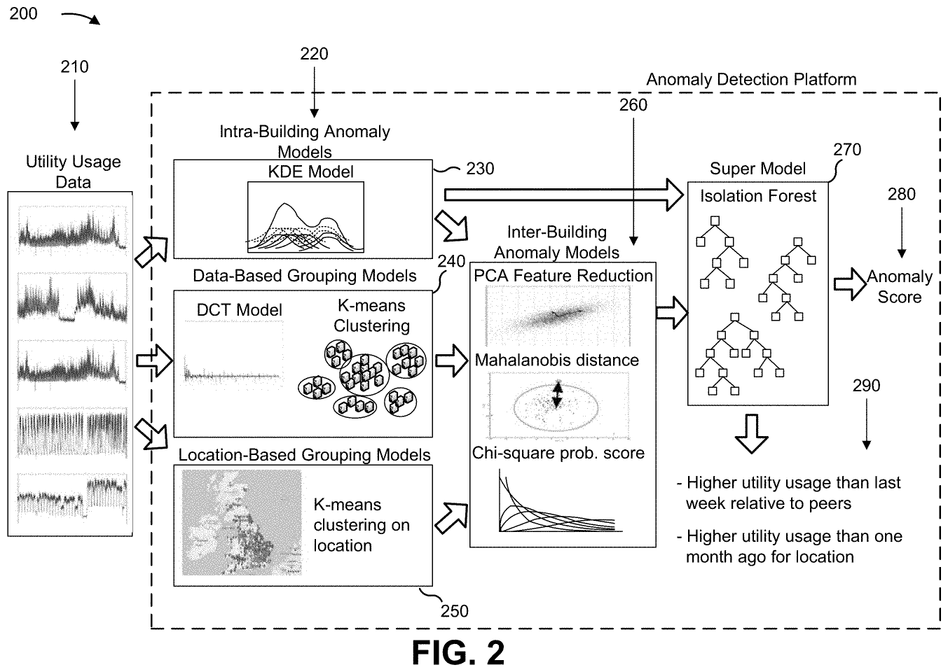

FIG. 2 is a diagram of an example implementation 200 described herein. As shown in FIG. 2, implementation 200 includes an anomaly detection platform. As shown by reference number 210, the anomaly detection platform may receive utility usage data, in a manner similar to that described elsewhere herein. As further shown by reference number 210, the utility usage data may include multiple sets of data (e.g., hundreds, thousands, or more sets of data) with different patterns of values. In this way, the anomaly detection platform may receive a complex data set that cannot be easily or efficiently processed by conventional computing resources.

As shown by reference number 220, the anomaly detection platform may process the utility usage data using a first set of models. For example, the first set of models may be similar to that described elsewhere herein. Continuing with the previous example, the first set of models may include a set of intra-building anomaly models (e.g., a KDE model shown by reference number 230). Additionally, or alternatively, the first set of models may include a set of data-based grouping models (e.g., a DCT model, a k-means clustering model, and/or the like shown by reference number 240). Additionally, or alternatively, the first set of models may include a set of location-based grouping models (e.g., a k-means clustering model based on location shown by reference number 250).

As shown by reference number 260, the anomaly detection platform may include a set of inter-building anomaly models as a second set of models. For example, the set of inter-building anomaly models may include a PCA feature reduction model, a Mahalanobis distance model, a chi-square probability score model, and/or the like, similar to those described elsewhere herein. As shown by reference number 270, the anomaly detection platform may include a super model similar to that described elsewhere herein to process first output from the first set of models and/or second output from the second set of models. As shown by reference number 280, the super model may output an anomaly score that indicates a likelihood of an anomaly being present in the utility usage data. Additionally, or alternatively, and as shown by reference number 290, the super model may output information that identifies an anomaly, a time period for the anomaly, and/or the like.

As indicated above, FIG. 2 is provided merely as an example. Other examples may differ from what is described with regard to FIG. 2.

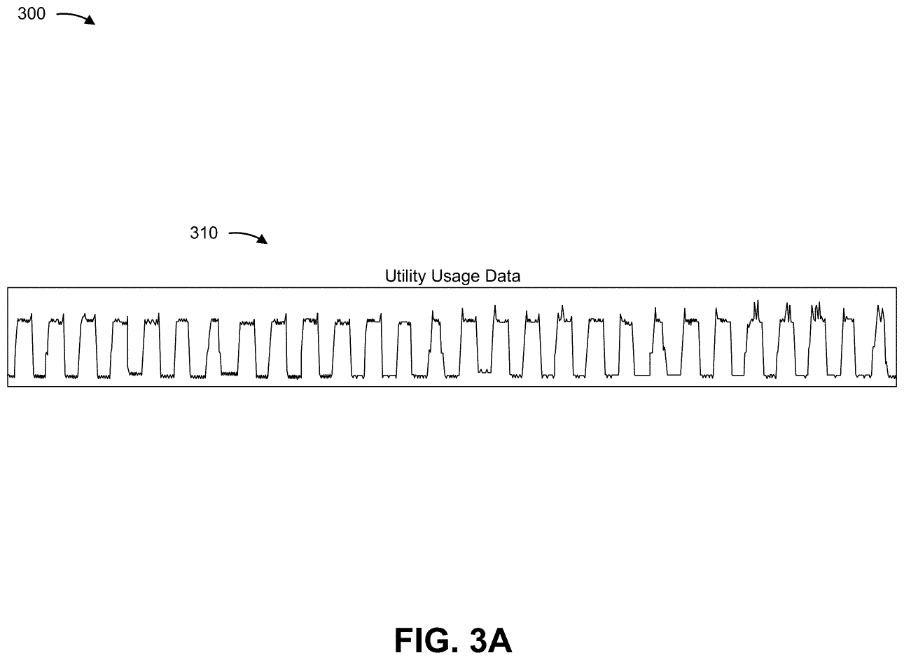

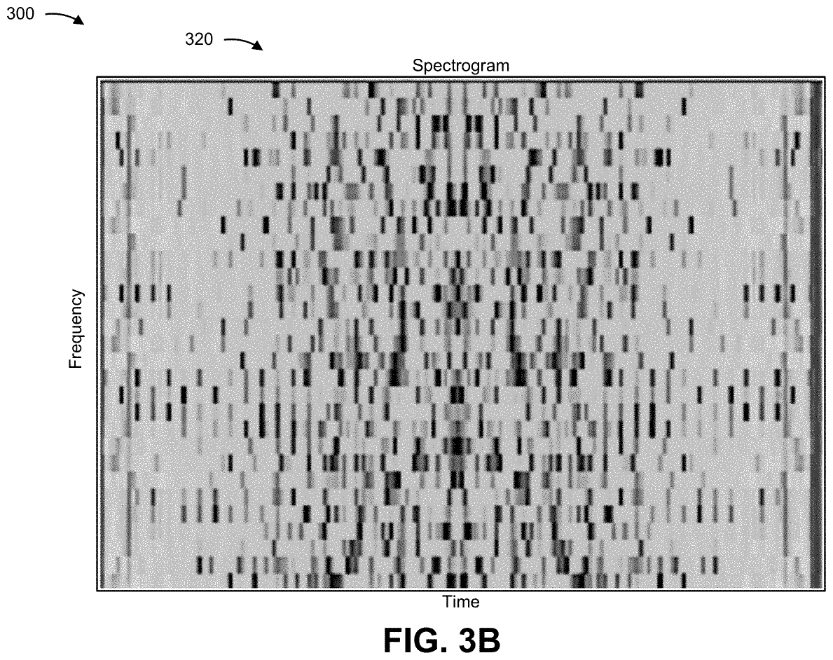

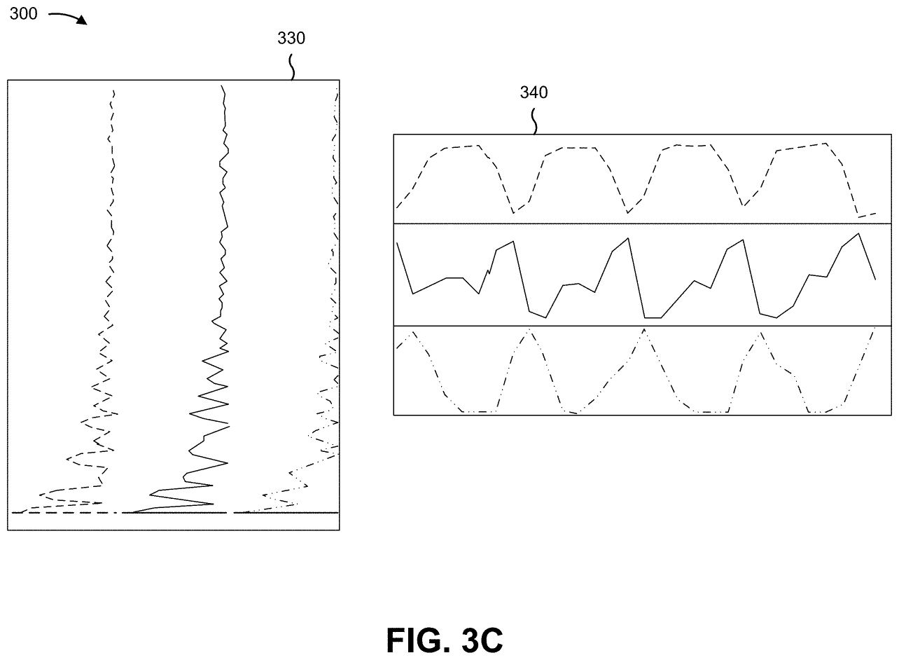

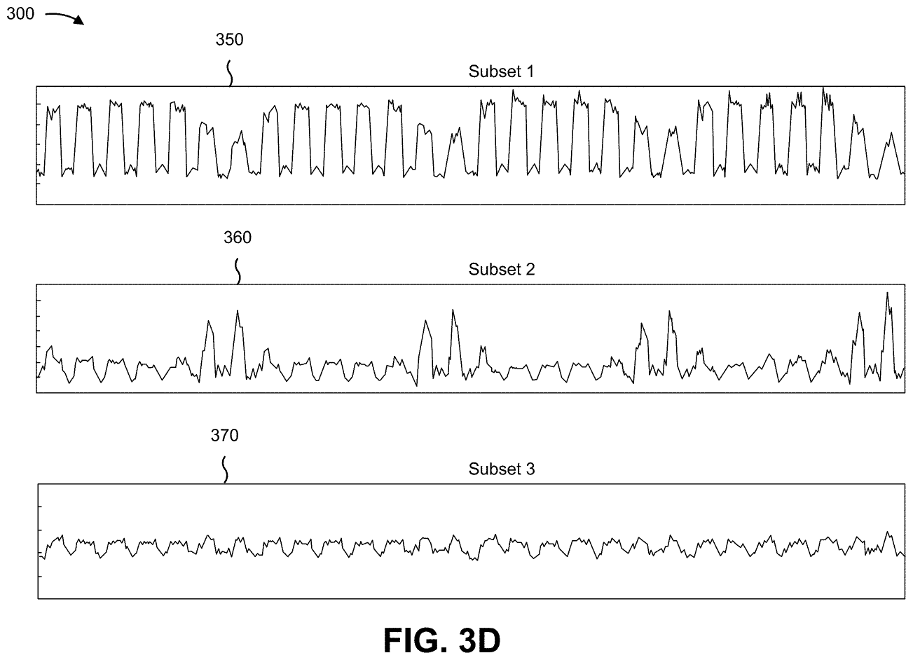

FIGS. 3A-3D are diagrams of one or more example implementations 300 described herein. FIGS. 3A-3D show one or more examples of performing a decomposition of utility usage data in a manner similar to that described elsewhere herein.

As shown in FIG. 3A, reference number 310 shows utility usage data that an anomaly detection platform may receive from a set of utility meters. In some implementations, the utility usage data may be related to different utility elements, such as different utility meters, different utilities, different buildings, different locations, and/or the like. In this way, the utility usage data may include a complex set of data that may be difficult, or impossible, for conventional computing resources to process without being overloaded.

Turning to FIG. 3B, and as shown by reference number 320, the anomaly detection platform may determine a spectrogram of the utility usage data using a short-time Fourier transform technique. For example, the anomaly detection platform may determine respective spectrograms for usage time series included in the utility usage data. In some implementations, the anomaly detection platform may determine the spectrogram to extract time-varying frequency subsets of data from the utility usage data.

Turning to FIG. 3C, the anomaly detection platform may process the spectrogram using a non-negative matrix factorization (NMF) algorithm. For example, the anomaly detection platform may use the NMF algorithm to decompose the spectrogram into multiple distinct subsets. Alternatively, the anomaly detection platform may use an independent component analysis (ICA) algorithm or another blind source separation (BSS) algorithm rather than the NMF algorithm. In some implementations, and as shown by reference number 330, the anomaly detection platform may use the NMF to decompose the spectrogram into a frequency dictionary matrix. Additionally, or alternatively, and as shown by reference number 340, the anomaly detection platform may use the NMF to decompose the spectrogram into a time-varying weight matrix.

Turning to FIG. 3D, the anomaly detection platform may process the distinct subsets of data using an inverse short-time Fourier transform technique to reconstruct the distinct subsets of data in a time domain after processing the spectrogram using the NMF algorithm. For example, and as shown by reference numbers 350 through 370, the anomaly detection platform may reconstruct various distinct subsets of data for different buildings, different utilities, different locations, and/or the like. In some implementations, the anomaly detection platform may process the distinct subsets in a manner similar to that described elsewhere herein to identify a possible anomaly in the data.

In some implementations, performing a decomposition of utility usage data facilitates solving a blind source separation problem that may be present in the utility usage data when the utility usage data includes various subsets of data. For example, performing a decomposition of utility usage data in this manner provides a way to solve the blind source separation problem when the blind source separation problem includes an infinite quantity of ways to decompose the utility usage data (e.g., by decomposing utility usage data into distinct subsets to provide insights and understanding into patterns, anomalies, and/or the like).

In this way, by performing the decomposition, the anomaly detection platform may analyze independent subsets of data for different buildings, may perform a more rigorous analysis of utility usage data that is associated with a threshold likelihood of including an anomaly, and/or the like. In addition, the decomposition facilitates analysis of patterns of usage data (e.g., among groups of buildings), identification of sources of anomalies in utility usage data, and/or the like. Further, utility usage data from different meters can be correlated, thereby improving an analysis of the utility usage data, thereby reducing or eliminating waste of one or more utilities, and/or the like.

As indicated above, FIGS. 3A-3D are provided merely as one or more examples. Other examples may differ from what is described with regard to FIGS. 3A-3D.

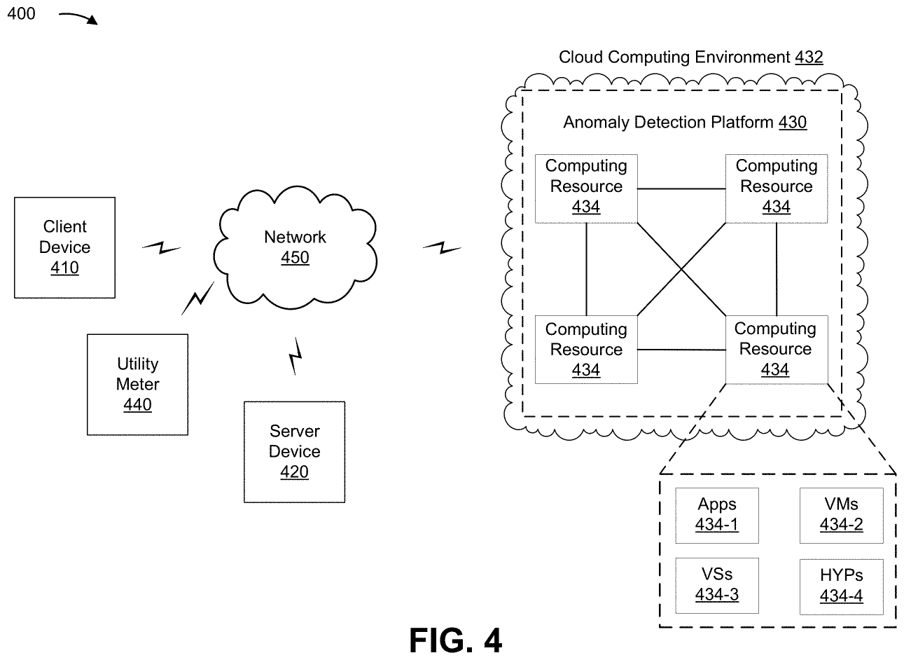

FIG. 4 is a diagram of an example environment 400 in which systems and/or methods described herein may be implemented. As shown in FIG. 4, environment 400 may include a client device 410, a server device 420, an anomaly detection platform 430 hosted within a cloud computing environment 432 that includes a set of computing resources 434, a utility meter 440, and a network 450. Devices of environment 400 may interconnect via wired connections, wireless connections, or a combination of wired and wireless connections.

Client device 410 includes one or more devices capable of receiving, generating, storing, processing, and/or providing utility usage data. For example, client device 410 may include a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), a desktop computer, or a similar type of device. In some implementations, client device 410 may receive, from anomaly detection platform 430, a result of an analysis of utility usage data performed by anomaly detection platform 430, as described elsewhere herein. In some implementations, a user device, as described elsewhere herein, may be the same as or similar to client device 410.

Server device 420 includes one or more devices capable of receiving, generating storing, processing, and/or providing utility usage data. For example, server device 420 may include a server (e.g., in a data center or a cloud computing environment), a data center (e.g., a multi-server micro datacenter), a workstation computer, a virtual machine (VM) provided in a cloud computing environment, or a similar type of device. In some implementations, server device 420 may include a communication interface that allows server device 420 to receive information from and/or transmit information to other devices in environment 400. In some implementations, server device 420 may be a physical device implemented within a housing, such as a chassis. In some implementations, server device 420 may be a virtual device implemented by one or more computer devices of a cloud computing environment or a data center. In some implementations, server device 420 may provide, to anomaly detection platform 430, utility usage data (or historical utility usage data), as described elsewhere herein.

Anomaly detection platform 430 includes one or more devices capable of receiving, generating, storing, processing, and/or providing utility usage data. For example, anomaly detection platform 430 may include a cloud server or a group of cloud servers. In some implementations, anomaly detection platform 430 may be designed to be modular such that certain software components can be swapped in or out depending on a particular need. As such, anomaly detection platform 430 may be easily and/or quickly reconfigured for different uses.

In some implementations, as shown in FIG. 4, anomaly detection platform 430 may be hosted in cloud computing environment 432. Notably, while implementations described herein describe anomaly detection platform 430 as being hosted in cloud computing environment 432, in some implementations, anomaly detection platform 430 may be non-cloud-based (i.e., may be implemented outside of a cloud computing environment) or may be partially cloud-based.

Cloud computing environment 432 includes an environment that hosts anomaly detection platform 430. Cloud computing environment 432 may provide computation, software, data access, storage, and/or other services that do not require end-user knowledge of a physical location and configuration of a system and/or a device that hosts anomaly detection platform 430. As shown, cloud computing environment 432 may include a group of computing resources 434 (referred to collectively as “computing resources 434” and individually as “computing resource 434”).

Computing resource 434 includes one or more personal computers, workstation computers, server devices, or another type of computation and/or communication device. In some implementations, computing resource 434 may host anomaly detection platform 430. The cloud resources may include compute instances executing in computing resource 434, storage devices provided in computing resource 434, data transfer devices provided by computing resource 434, etc. In some implementations, computing resource 434 may communicate with other computing resources 434 via wired connections, wireless connections, or a combination of wired and wireless connections.

As further shown in FIG. 4, computing resource 434 may include a group of cloud resources, such as one or more applications (“APPs”) 434-1, one or more virtual machines (“VMs”) 434-2, one or more virtualized storages (“VSs”) 434-3, or one or more hypervisors (“HYPs”) 434-4.

Application 434-1 includes one or more software applications that may be provided to or accessed by one or more devices of environment 400. Application 434-1 may eliminate a need to install and execute the software applications on devices of environment 400. For example, application 434-1 may include software associated with anomaly detection platform 430 and/or any other software capable of being provided via cloud computing environment 432. In some implementations, one application 434-1 may send/receive information to/from one or more other applications 434-1, via virtual machine 434-2. In some implementations, application 434-1 may include a software application associated with one or more databases and/or operating systems. For example, application 434-1 may include an enterprise application, a functional application, an analytics application, and/or the like.

Virtual machine 434-2 includes a software implementation of a machine (e.g., a computer) that executes programs like a physical machine. Virtual machine 434-2 may be either a system virtual machine or a process virtual machine, depending upon use and degree of correspondence to any real machine by virtual machine 434-2. A system virtual machine may provide a complete system platform that supports execution of a complete operating system (“OS”). A process virtual machine may execute a single program, and may support a single process. In some implementations, virtual machine 434-2 may execute on behalf of a user (e.g., a user of client device 410), and may manage infrastructure of cloud computing environment 432, such as data management, synchronization, or long-duration data transfers.

Virtualized storage 434-3 includes one or more storage systems and/or one or more devices that use virtualization techniques within the storage systems or devices of computing resource 434. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 434-4 provides hardware virtualization techniques that allow multiple operating systems (e.g., “guest operating systems”) to execute concurrently on a host computer, such as computing resource 434. Hypervisor 434-4 may present a virtual operating platform to the guest operating systems, and may manage the execution of the guest operating systems. Multiple instances of a variety of operating systems may share virtualized hardware resources.

Utility meter 440 includes one or more devices capable of receiving, generating, storing, processing, and/or providing utility usage data. For example, utility meter 440 may include an electricity meter, a gas meter, a water meter, a sewage meter, a telecommunications meter, a smart utility meter, and/or the like. In some implementations, utility meter 440 may measure a utility usage of a utility for a building, for a particular floor of a building, for a group of buildings, and/or the like, and may store utility usage data that identifies the utility usage, as described elsewhere herein. In some implementations, utility meter 440 may provide, to anomaly detection platform 430, utility usage data for processing, as described elsewhere herein.

Network 450 includes one or more wired and/or wireless networks. For example, network 450 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 4 are provided as one or more examples. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

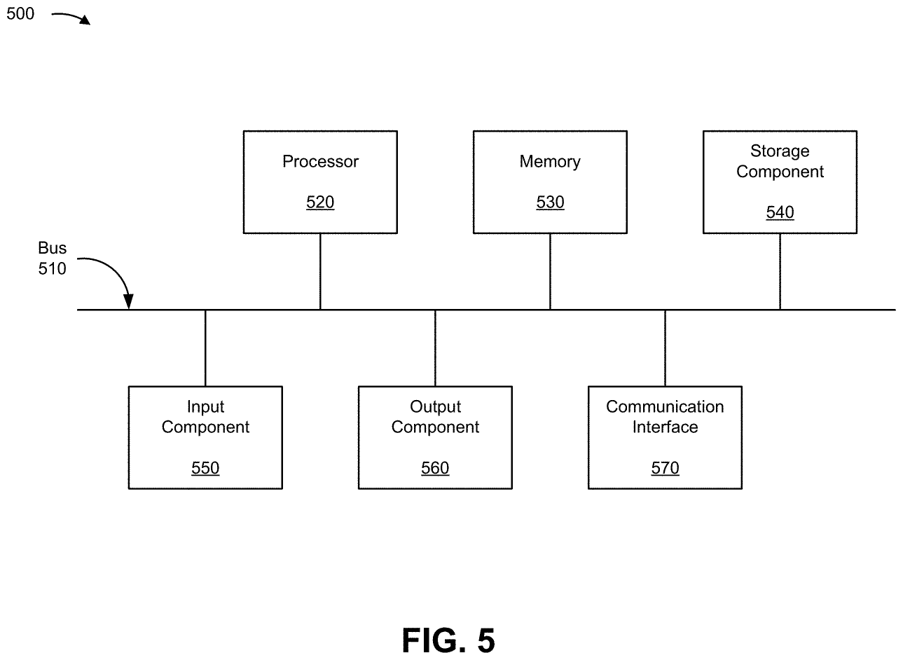

FIG. 5 is a diagram of example components of a device 500. Device 500 may correspond to client device 410, server device 420, anomaly detection platform 430, computing resource 434, and/or utility meter 440. In some implementations, client device 410, server device 420, anomaly detection platform 430, computing resource 434, and/or utility meter 440 may include one or more devices 500 and/or one or more components of device 500. As shown in FIG. 5, device 500 may include a bus 510, a processor 520, a memory 530, a storage component 540, an input component 550, an output component 560, and a communication interface 570.

Bus 510 includes a component that permits communication among multiple components of device 500. Processor 520 is implemented in hardware, firmware, and/or a combination of hardware and software. Processor 520 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 520 includes one or more processors capable of being programmed to perform a function. Memory 530 includes a random access memory (RAM), a read only memory (ROM), and/or another type of dynamic or static storage device (e.g., a flash memory, a magnetic memory, and/or an optical memory) that stores information and/or instructions for use by processor 520.

Storage component 540 stores information and/or software related to the operation and use of device 500. For example, storage component 540 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 550 includes a component that permits device 500 to receive information, such as via user input (e.g., a touch screen display, a keyboard, a keypad, a mouse, a button, a switch, and/or a microphone). Additionally, or alternatively, input component 550 may include a component for determining location (e.g., a global positioning system (GPS) component) and/or a sensor (e.g., an accelerometer, a gyroscope, an actuator, another type of positional or environmental sensor, and/or the like). Output component 560 includes a component that provides output information from device 500 (via, e.g., a display, a speaker, a haptic feedback component, an audio or visual indicator, and/or the like).

Communication interface 570 includes a transceiver-like component (e.g., a transceiver, a separate receiver, a separate transmitter, and/or the like) that enables device 500 to communicate with other devices, such as via a wired connection, a wireless connection, or a combination of wired and wireless connections. Communication interface 570 may permit device 500 to receive information from another device and/or provide information to another device. For example, communication interface 570 may include an Ethernet interface, an optical interface, a coaxial interface, an infrared interface, a radio frequency (RF) interface, a universal serial bus (USB) interface, a Wi-Fi interface, a cellular network interface, and/or the like.

Device 500 may perform one or more processes described herein. Device 500 may perform these processes based on processor 520 executing software instructions stored by a non-transitory computer-readable medium, such as memory 530 and/or storage component 540. As used herein, the term “computer-readable medium” refers to a non-transitory memory device. A memory device includes memory space within a single physical storage device or memory space spread across multiple physical storage devices.

Software instructions may be read into memory 530 and/or storage component 540 from another computer-readable medium or from another device via communication interface 570. When executed, software instructions stored in memory 530 and/or storage component 540 may cause processor 520 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

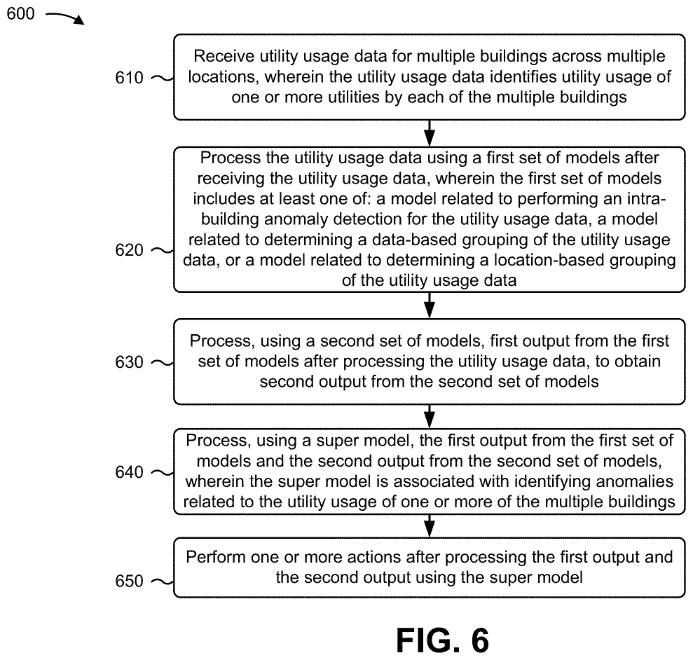

FIG. 6 is a flow chart of an example process 600 for site-specific anomaly detection. In some implementations, one or more process blocks of FIG. 6 may be performed by an anomaly detection platform (e.g., anomaly detection platform 430). In some implementations, one or more process blocks of FIG. 6 may be performed by another device or a group of devices separate from or including the anomaly detection platform, such as a client device (e.g., client device 410), a server device (e.g., server device 420), a computing resource (e.g., computing resource 434), and/or a utility meter (e.g., utility meter 440).

As shown in FIG. 6, process 600 may include receiving utility usage data for multiple buildings across multiple locations, wherein the utility usage data identifies utility usage of one or more utilities by each of the multiple buildings (block 610). For example, the anomaly detection platform (e.g., using computing resource 434, processor 520, memory 530, storage component 540, input component 550, communication interface 570, and/or the like) may receive utility usage data for multiple buildings across multiple locations, as described above. In some implementations, the utility usage data identifies utility usage of one or more utilities by each of the multiple buildings.

As further shown in FIG. 6, process 600 may include processing the utility usage data using a first set of models after receiving the utility usage data, wherein the first set of models includes at least one of: a model related to performing an intra-building anomaly detection for the utility usage data, a model related to determining a data-based grouping of the utility usage data, or a model related to determining a location-based grouping of the utility usage data (block 620). For example, the anomaly detection platform (e.g., using computing resource 434, processor 520, and/or the like) may process the utility usage data using a first set of models after receiving the utility usage data, as described above. In some implementations, the first set of models includes at least one of: a model related to performing an intra-building anomaly detection for the utility usage data, a model related to determining a data-based grouping of the utility usage data, or a model related to determining a location-based grouping of the utility usage data.

As further shown in FIG. 6, process 600 may include processing, using a second set of models, first output from the first set of models after processing the utility usage data, to obtain second output from the second set of models (block 630). For example, the anomaly detection platform (e.g., using computing resource 434, processor 520, and/or the like) may process, using a second set of models, first output from the first set of models after processing the utility usage data, to obtain second output from the second set of models, as described above.

As further shown in FIG. 6, process 600 may include processing, using a super model, the first output from the first set of models and the second output from the second set of models, wherein the super model is associated with identifying anomalies related to the utility usage of one or more of the multiple buildings (block 640). For example, the anomaly detection platform (e.g., using computing resource 434, processor 520, and/or the like) may process, using a super model, the first output from the first set of models and the second output from the second set of models, as described above. In some implementations, the super model is associated with identifying anomalies related to the utility usage of one or more of the multiple buildings.

As further shown in FIG. 6, process 600 may include performing one or more actions after processing the first output and the second output using the super model (block 650). For example, the anomaly detection platform (e.g., using computing resource 434, processor 520, memory 530, storage component 540, output component 560, communication interface 570, and/or the like) may perform one or more actions after processing the first output and the second output using the super model, as described above.

Process 600 may include additional implementations, such as any single implementation or any combination of implementations described below and/or in connection with one or more other processes described elsewhere herein.

In some implementations, the anomaly detection platform may receive the utility usage data from a respective set of utility meters associated with the multiple buildings. In some implementations, the model, related to performing the intra-building anomaly detection for the utility usage data, includes a kernel density estimation (KDE) model; wherein the model, related to determining the data-based grouping of the utility usage data, includes at least one of: a discrete cosine transform (DCT) model, or a k-means clustering model; and wherein the model, related to determining the location-based grouping of the utility usage data, includes another k-means clustering model.

In some implementations, the second set of models includes at least one of: a principal component analysis (PCA) feature reduction model, a Mahalanobis distance model, or a chi-square probability model. In some implementations, the super model includes an isolation forest model.

In some implementations, the anomaly detection platform may perform a decomposition of the utility usage data, after processing the first output and the second output, to identify a utility element of the one or more utilities that caused a possible anomaly detected in the utility usage data. In some implementations, the anomaly detection platform may send, to another device, a message that includes information that identifies the utility element that caused the possible anomaly.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

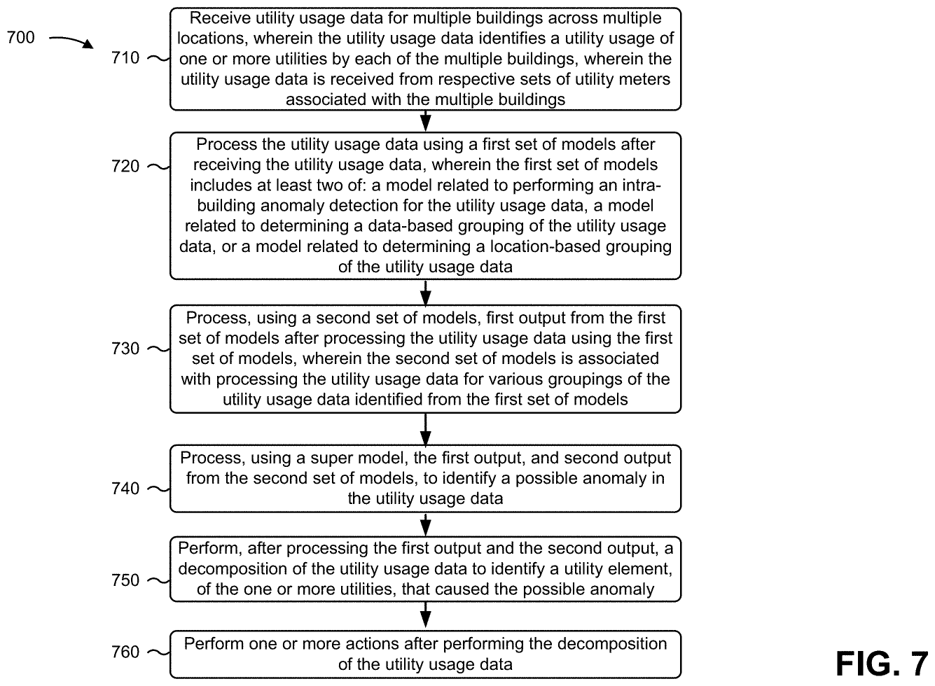

FIG. 7 is a flow chart of an example process 700 for site-specific anomaly detection. In some implementations, one or more process blocks of FIG. 7 may be performed by an anomaly detection platform (e.g., anomaly detection platform 430). In some implementations, one or more process blocks of FIG. 7 may be performed by another device or a group of devices separate from or including the anomaly detection platform, such as a client device (e.g., client device 410), a server device (e.g., server device 420), a computing resource (e.g., computing resource 434), and/or a utility meter (e.g., utility meter 440).

As shown in FIG. 7, process 700 may include receiving utility usage data for multiple buildings across multiple locations, wherein the utility usage data identifies a utility usage of one or more utilities by each of the multiple buildings, wherein the utility usage data is received from respective sets of utility meters associated with the multiple buildings (block 710). For example, the anomaly detection platform (e.g., using computing resource 434, processor 520, memory 530, storage component 540, input component 550, communication interface 570, and/or the like) may receive utility usage data for multiple buildings across multiple locations, as described above. In some implementations, the utility usage data identifies a utility usage of one or more utilities by each of the multiple buildings. In some implementations, the utility usage data is received from respective sets of utility meters associated with the multiple buildings.

As further shown in FIG. 7, process 700 may include processing the utility usage data using a first set of models after receiving the utility usage data, wherein the first set of models includes at least two of: a model related to performing an intra-building anomaly detection for the utility usage data, a model related to determining a data-based grouping of the utility usage data, or a model related to determining a location-based grouping of the utility usage data (block 720). For example, the anomaly detection platform (e.g., using computing resource 434, processor 520, and/or the like) may process the utility usage data using a first set of models after receiving the utility usage data, as described above. In some implementations, the first set of models includes at least two of: a model related to performing an intra-building anomaly detection for the utility usage data, a model related to determining a data-based grouping of the utility usage data, or a model related to determining a location-based grouping of the utility usage data.

As further shown in FIG. 7, process 700 may include processing, using a second set of models, first output from the first set of models after processing the utility usage data using the first set of models, wherein the second set of models is associated with processing the utility usage data for various groupings of the utility usage data identified from the first set of models (block 730). For example, the anomaly detection platform (e.g., using computing resource 434, processor 520, and/or the like) may process, using a second set of models, first output from the first set of models after processing the utility usage data using the first set of models, as described above. In some implementations, the second set of models is associated with processing the utility usage data for various groupings of the utility usage data identified from the first set of models.

As further shown in FIG. 7, process 700 may include processing, using a super model, the first output, and second output from the second set of models, to identify a possible anomaly in the utility usage data (block 740). For example, the anomaly detection platform (e.g., using computing resource 434, processor 520, and/or the like) may process, using a super model, the first output and second output from the second set of models to identify a possible anomaly in the utility usage data, as described above.

As further shown in FIG. 7, process 700 may include performing, after processing the first output and the second output, a decomposition of the utility usage data to identify a utility element, of the one or more utilities, that caused the possible anomaly (block 750). For example, the anomaly detection platform (e.g., using computing resource 434, processor 520, and/or the like) may perform, after processing the first output and the second output, a decomposition of the utility usage data to identify a utility element, of the one or more utilities, that caused the possible anomaly, as described above.

As further shown in FIG. 7, process 700 may include performing one or more actions after performing the decomposition of the utility usage data (block 760). For example, the anomaly detection platform (e.g., using computing resource 434, processor 520, memory 530, storage component 540, output component 560, communication interface 570, and/or the like) may perform one or more actions after performing the decomposition of the utility usage data, as described above.

Process 700 may include additional implementations, such as any single implementation or any combination of implementations described below and/or in connection with one or more other processes described elsewhere herein.

In some implementations, a utility meter, of the respective sets of utility meters, includes at least one of: an electricity meter, a gas meter, a water meter, a sewage meter, or a telecommunications meter. In some implementations, the anomaly detection platform may determine, after processing the first output and the second output with the super model, that a score output by the super model satisfies a threshold, and may determine that the possible anomaly is present in the utility usage data based on determining that the score satisfies the threshold.

In some implementations, the anomaly detection platform may determine the decomposition after determining that the possible anomaly is present in the utility usage data. In some implementations, the anomaly detection platform may process the utility usage data using a short-time Fourier transform technique to form a spectrogram of the utility usage data in a frequency domain; may process the spectrogram of the utility usage data using a non-negative matrix factorization (NMF) algorithm to decompose the spectrogram into distinct subsets of data after processing the utility usage data using the short-time Fourier transform technique; and may process the distinct subsets of data using an inverse short-time Fourier transform technique to reconstruct the distinct subsets of data in a time domain after processing the spectrogram using the NMF algorithm.

In some implementations, the anomaly detection platform may send, to another device that utilizes the utility element, a set of instructions related to modifying operations of the other device based on the possible anomaly. In some implementations, the anomaly detection platform may identify the utility element that caused the possible anomaly after performing the decomposition; may generate a recommendation related to addressing the possible anomaly after identifying the utility element; and may output the recommendation for display after generating the recommendation.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

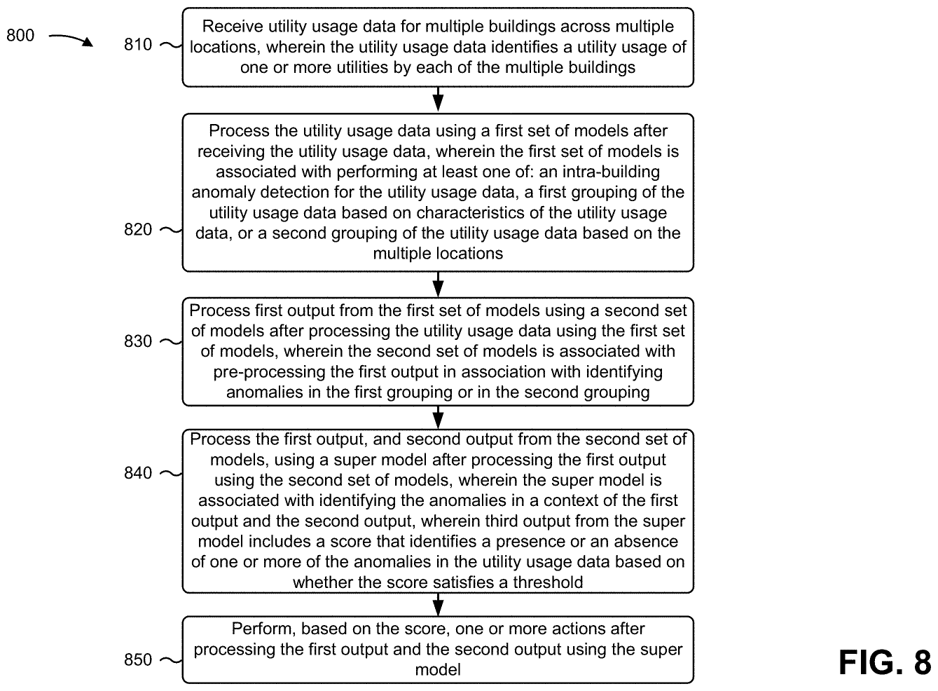

FIG. 8 is a flow chart of an example process 800 for site-specific anomaly detection. In some implementations, one or more process blocks of FIG. 8 may be performed by an anomaly detection platform (e.g., anomaly detection platform 430). In some implementations, one or more process blocks of FIG. 8 may be performed by another device or a group of devices separate from or including the anomaly detection platform, such as a client device (e.g., client device 410), a server device (e.g., server device 420), a computing resource (e.g., computing resource 434), and/or a utility meter (e.g., utility meter 440).

As shown in FIG. 8, process 800 may include receiving utility usage data for multiple buildings across multiple locations, wherein the utility usage data identifies a utility usage of one or more utilities by each of the multiple buildings (block 810). For example, the anomaly detection platform (e.g., using computing resource 434, processor 520, memory 530, storage component 540, input component 550, communication interface 570, and/or the like) may receive utility usage data for multiple buildings across multiple locations, as described above. In some implementations, the utility usage data identifies a utility usage of one or more utilities by each of the multiple buildings.

As further shown in FIG. 8, process 800 may include processing the utility usage data using a first set of models after receiving the utility usage data, wherein the first set of models is associated with performing at least one of: an intra-building anomaly detection for the utility usage data, a first grouping of the utility usage data based on characteristics of the utility usage data, or a second grouping of the utility usage data based on the multiple locations (block 820). For example, the anomaly detection platform (e.g., using computing resource 434, processor 520, and/or the like) may process the utility usage data using a first set of models after receiving the utility usage data, as described above. In some implementations, the first set of models is associated with performing at least one of: an intra-building anomaly detection for the utility usage data, a first grouping of the utility usage data based on characteristics of the utility usage data, or a second grouping of the utility usage data based on the multiple locations.

As further shown in FIG. 8, process 800 may include processing first output from the first set of models using a second set of models after processing the utility usage data using the first set of models, wherein the second set of models is associated with pre-processing the first output in association with identifying anomalies in the first grouping or in the second grouping (block 830). For example, the anomaly detection platform (e.g., using computing resource 434, processor 520, and/or the like) may process first output from the first set of models using a second set of models after processing the utility usage data using the first set of models, as described above. In some implementations, the second set of models is associated with pre-processing the first output in association with identifying anomalies in the first grouping or in the second grouping.

As further shown in FIG. 8, process 800 may include processing the first output, and second output from the second set of models, using a super model after processing the first output using the second set of models, wherein the super model is associated with identifying the anomalies in a context of the first output and the second output, wherein third output from the super model includes a score that identifies a presence of one or more of the anomalies in the utility usage data (block 840). For example, the anomaly detection platform (e.g., using computing resource 434, processor 520, and/or the like) may process the first output and second output from the second set of models using a super model after processing the first output using the second set of models, as described above. In some implementations, the super model is associated with identifying the anomalies in a context of the first output and the second output, wherein third output from the super model includes a score that identifies a presence or an absence of one or more of the anomalies in the utility usage data based on whether the score satisfies a threshold.

As further shown in FIG. 8, process 800 may include performing, based on the score, one or more actions after processing the first output and the second output using the super model (block 850). For example, the anomaly detection platform (e.g., using computing resource 434, processor 520, memory 530, storage component 540, output component 560, communication interface 570, and/or the like) may perform, based on the score, one or more actions after processing the first output and the second output using the super model, as described above.

Process 800 may include additional implementations, such as any single implementation or any combination of implementations described below and/or in connection with one or more other processes described elsewhere herein.

In some implementations, the anomaly detection platform may detect, after processing the first output and the second output, the presence of the one or more of the anomalies based on the score satisfying the threshold; and may perform the one or more actions after detecting the presence of the one or more of the anomalies. In some implementations, the anomaly detection platform may perform, after processing the first output and the second output, a decomposition of the utility usage data to identify a utility element, of the one or more utilities, that caused the one or more of the anomalies.

In some implementations, the anomaly detection platform may process the utility usage data to form a spectrogram of the utility usage data in a frequency domain; may process the spectrogram of the utility usage data to decompose the spectrogram into distinct subsets of data after processing the utility usage data to form the spectrogram; and may process the distinct subsets of data to reconstruct the distinct subsets of data in a time domain after processing the spectrogram. In some implementations, the anomaly detection platform may generate a report that identifies a source of the one or more of the anomalies based on the third output and after processing the first output and the second output; and may output the report for display after generating the report. In some implementations, the anomaly detection platform may perform the one or more actions based on the source of the one or more of the anomalies identified in the report.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations to the precise form disclosed. Modifications and variations may be made in light of the above disclosure or may be acquired from practice of the implementations.

As used herein, the term “component” is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc., depending on the context.

It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
receiving, by a device, utility usage data for multiple buildings across multiple locations,
wherein the utility usage data identifies utility usage of one or more utilities by each of the multiple buildings;
processing, by the device, the utility usage data using a first set of models after receiving the utility usage data,
wherein the first set of models includes at least one of:
a model related to performing an intra-building anomaly detection for the utility usage data,
a model related to determining a data-based grouping of the utility usage data, or
a model related to determining a location-based grouping of the utility usage data;
processing, by the device and using a second set of models, first output from the first set of models after processing the utility usage data, to obtain second output from the second set of models;
processing, by the device and using a super model, the first output from the first set of models and the second output from the second set of models,
wherein the super model is associated with identifying anomalies related to the utility usage of one or more of the multiple buildings; and
performing, by the device, one or more actions after processing the first output and the second output using the super model.

2. The method of claim 1, wherein receiving the utility usage data comprises:
receiving the utility usage data from a respective set of utility meters associated with the multiple buildings.

3. The method of claim 1, wherein the model, related to performing the intra-building anomaly detection for the utility usage data, includes a kernel density estimation (KDE) model;
wherein the model, related to determining the data-based grouping of the utility usage data, includes at least one of:
a discrete cosine transform (DCT) model, or
a k-means clustering model; and
wherein the model, related to determining the location-based grouping of the utility usage data, includes another k-means clustering model.

4. The method of claim 1, wherein the second set of models includes at least one of:
a principal component analysis (PCA) feature reduction model,
a Mahalanobis distance model, or
a chi-square probability model.

5. The method of claim 1, wherein the super model includes an isolation forest model.

6. The method of claim 1, further comprising:
performing a decomposition of the utility usage data, after processing the first output and the second output, to identify a utility element of the one or more utilities that caused a possible anomaly detected in the utility usage data.

7. The method of claim 6, wherein performing the one or more actions comprises:
sending, to another device, a message that includes information that identifies the utility element that caused the possible anomaly.

8. A device, comprising:
one or more memories; and
one or more processors, communicatively coupled to the one or more memories, to:
receive utility usage data for multiple buildings across multiple locations,
wherein the utility usage data identifies a utility usage of one or more utilities by each of the multiple buildings,
wherein the utility usage data is received from respective sets of utility meters associated with the multiple buildings;
process the utility usage data using a first set of models after receiving the utility usage data,
wherein the first set of models includes at least two of:
a model related to performing an intra-building anomaly detection for the utility usage data,
a model related to determining a data-based grouping of the utility usage data, or
a model related to determining a location-based grouping of the utility usage data;
process, using a second set of models, first output from the first set of models after processing the utility usage data using the first set of models,
wherein the second set of models is associated with processing the utility usage data for various groupings of the utility usage data identified from the first set of models;
process, using a super model, the first output, and second output from the second set of models, to identify a possible anomaly in the utility usage data;
perform, after processing the first output and the second output, a decomposition of the utility usage data to identify a utility element, of the one or more utilities, that caused the possible anomaly; and
perform one or more actions after performing the decomposition of the utility usage data.

9. The device of claim 8, wherein a utility meter, of the respective sets of utility meters, includes at least one of:
an electricity meter,
a gas meter,
a water meter,
a sewage meter, or
a telecommunications meter.

10. The device of claim 8, wherein the one or more processors are further to:
determine, after processing the first output and the second output with the super model, that a score output by the super model satisfies a threshold; and
determine that the possible anomaly is present in the utility usage data based on determining that the score satisfies the threshold.

11. The device of claim 10, wherein the one or more processors, when performing the decomposition, are to:
determine the decomposition after determining that the possible anomaly is present in the utility usage data.

12. The device of claim 8, wherein the one or more processors, when performing the decomposition, are to:
process the utility usage data using a short-time Fourier transform technique to form a spectrogram of the utility usage data in a frequency domain;
process the spectrogram of the utility usage data using a non-negative matrix factorization (NMF) algorithm to decompose the spectrogram into distinct subsets of data after processing the utility usage data using the short-time Fourier transform technique; and
process the distinct subsets of data using an inverse short-time Fourier transform technique to reconstruct the distinct subsets of data in a time domain after processing the spectrogram using the NMF algorithm.

13. The device of claim 8, wherein the one or more processors, when performing the one or more actions, are to:
send, to another device that utilizes the utility element, a set of instructions related to modifying operations of the other device based on the possible anomaly.

14. The device of claim 8, wherein the one or more processors, when performing the one or more actions, are to:
identify the utility element that caused the possible anomaly after performing the decomposition;
generate a recommendation related to addressing the possible anomaly after identifying the utility element; and
output the recommendation for display after generating the recommendation.

15. A non-transitory computer-readable medium storing instructions, the instructions comprising:
one or more instructions that, when executed by one or more processors, cause the one or more processors to:
receive utility usage data for multiple buildings across multiple locations,
wherein the utility usage data identifies a utility usage of one or more utilities by each of the multiple buildings;
process the utility usage data using a first set of models after receiving the utility usage data,
wherein the first set of models is associated with performing at least one of:
an intra-building anomaly detection for the utility usage data,
a first grouping of the utility usage data based on characteristics of the utility usage data, or
a second grouping of the utility usage data based on the multiple locations;
process first output from the first set of models using a second set of models after processing the utility usage data using the first set of models,
wherein the second set of models is associated with pre-processing the first output in association with identifying anomalies in the first grouping or in the second grouping;
process the first output, and second output from the second set of models, using a super model after processing the first output using the second set of models,
wherein the super model is associated with identifying the anomalies in a context of the first output and the second output,
wherein third output from the super model includes a score that identifies a presence or an absence of one or more of the anomalies in the utility usage data based on whether the score satisfies a threshold; and
perform, based on the score, one or more actions after processing the first output and the second output using the super model.

16. The non-transitory computer-readable medium of claim 15, wherein the one or more instructions, when executed by the one or more processors, further cause the one or more processors to:
detect, after processing the first output and the second output, the presence of the one or more of the anomalies based on the score satisfying the threshold; and
wherein the one or more instructions, that cause the one or more processors to perform the one or more actions, cause the one or more processors to:
perform the one or more actions after detecting the presence of the one or more of the anomalies.

17. The non-transitory computer-readable medium of claim 15, wherein the one or more instructions, when executed by the one or more processors, further cause the one or more processors to:
perform, after processing the first output and the second output, a decomposition of the utility usage data to identify a utility element, of the one or more utilities, that caused the one or more of the anomalies.

18. The non-transitory computer-readable medium of claim 17, wherein the one or more instructions, that cause the one or more processors to perform the decomposition, cause the one or more processors to:
process the utility usage data to form a spectrogram of the utility usage data in a frequency domain;
process the spectrogram of the utility usage data to decompose the spectrogram into distinct subsets of data after processing the utility usage data to form the spectrogram; and
process the distinct subsets of data to reconstruct the distinct subsets of data in a time domain after processing the spectrogram.

19. The non-transitory computer-readable medium of claim 15, wherein the one or more instructions, when executed by the one or more processors, further cause the one or more processors to:
generate a report that identifies a source of the one or more of the anomalies based on the third output and after processing the first output and the second output; and
output the report for display after generating the report.

20. The non-transitory computer-readable medium of claim 19, wherein the one or more instructions, that cause the one or more processors to perform the one or more actions, cause the one or more processors to:
perform the one or more actions based on the source of the one or more of the anomalies identified in the report.
